(19) United States
(12) Patent Application Publication
(10) Pub. No.: US 2014/0318665 A1
(43) Pub. Date: Oct. 30, 2014

(54) Container Coupler For Transferring Viscous Fluids

(71) Applicant: Eve Balembois, Los Angeles, CA (US)

(72) Inventor: Eve Balembois, Los Angeles, CA (US)

(21) Appl. No.: 14/013,450

(22) Filed: Aug. 29, 2013

Related U.S. Application Data
(60) Provisional application No. 61/816,491, filed on Apr. 26, 2013.

(51) Int. Cl. B67D 7/02

(52) U.S. Cl. CPC B67D 7/0288
USPC 141/1; 141/319

(57) ABSTRACT

A container coupler for either transferring viscous fluids or holding a vessel upside down includes an engaging portion for encircling the mouth of a lower vessel and an aperture for engaging an upper vessel. A conical surface surrounding the aperture causes fluid spilled on the coupler to travel to the aperture and into the lower vessel. With the upper vessel engaged on the coupler, a portion of the upper vessel is disposed below the mouth of, and within the lower vessel to add stability, prevent leakage and decrease the height of the stacked vessels.

### CROSS-REFERENCE TO RELATED APPLICATION

This application claims the benefit of the filing date of provisional application No. 61/816,491, filed on Apr. 26, 2013.

### BACKGROUND

Decanters of viscous liquids such as lotions or gels are typically sold in the same bottles used for runny or watery fluids. Examples include bath items such as lotions, conditioners and shampoos, and occasionally food items such as ketchup or honey at room temperature. Currently a significant quantity of product is wasted due to the inability of a user to decant viscous liquids from half-empty bottles. Current solutions addressing this problem include balancing bottles upside down, shaking, squeezing plastic bottles to the point of crushing them, or even cutting them open to reach the remaining product.

Connection devices for transferring fluids are known in the art. Moisio et al (U.S. Pat. No. 6,237,649) discloses a dual vial connecting system for lyophilized products, including a cylindrical screwing closing and connection plastic sleeve having a plastic perforable membrane located between the upper portion and lower portion. An elastomer sealing ring fixed around a cylindrical plastic skirt is located in the inner lower portion, and an elastomer sealing plug fixed by a collar and an annular rib ensures an air and liquid-tight system. This apparatus is disfavored for simple decantation since it has multiple parts made of expensive materials, and is air-tight, which tends to prevent liquid transfer of viscous fluids.

Barnoski et al (U.S. Pat. No. 6,182,720) discloses a quick connecting fluid transfer device comprising a vertical connector having an inverted funnel at its top and a conically downwardly tapered funnel at its bottom with a collecting portion formed generally around its mid-span. The upper inverted funnel has a longitudinal slot and an opening is formed in the collecting portion allowing fluid to pass between the upper container and lower container. This type of apparatus is disfavored due to its unwieldy shape, which makes it inconvenient to store. Furthermore, lacking an anchoring means of any kind, it promotes instability, and allows the upper bottle to lean, possibly tipping over both bottles.

Chudy (U.S. Pat. No. 5,884,678) discloses a connector device for holding two necks in an abutting relationship. It is designed to connect two tubes or containers so as to allow the transfer of fluids from one tube or container to the other. The connector device includes a tubular member having an inner wall that includes longitudinal slits and flange. This type of apparatus is also not preferred for transferring viscous fluids since it prevents air exchange between the containers.

Fluster (U.S. Pat. No. 3,877,499) discloses a fluid coupling device for transferring viscous fluids from one bottle to another bottle. It includes an upper, flared section and a flange. And air passageway is formed in the upper coupling section and extends through the flange into the lower coupling section allowing air to be displaced by the fluid. This apparatus is only adapted for a specific sized bottle capable of receiving the flange, and is incapable of supporting viscous fluid transfer between a variety of bottle sizes and styles.

Therefore a need exists for a container coupling device to transfer viscous fluids from one bottle to another, which securely anchors to a receiving bottle, allowing air to travel between the bottles, and which is compact and easy to store. A need also exists for a fluid coupling device which is simply designed, easy to mold from inexpensive materials, and which is spill resistant to avoid viscous fluids spilling as they are transferred.

### SUMMARY

A fluid container coupler is disclosed for decanting viscous fluids from an upper vessel to a lower vessel. The coupler serves as an inverted bottle holder and primer to securely and perpetually hold capped bottles upside down, ensuring liquid is always at the cap ready to be dispensed and thereby avoiding the need for waiting for a viscous liquid to reach the spout, or violently shaking and squeezing the bottle. The coupler also serves as an inverted bottle drainer for removing the last few ounces of a viscous liquid from a bottle by removing the bottle cap and pump and inverting a bottle over the coupler.

The coupler includes an engaging portion for encircling the mouth of the lower vessel and an aperture for engaging the upper vessel. A cylindrical hammock which is a conical surface surrounding the aperture ensures the upper vessel will be securely held, and in some instances that fluid on the coupler travels to the aperture and into the lower vessel. The conical surface is preferably arranged such that, with the upper vessel engaged on the coupler, a portion of the upper vessel is disposed below the mouth of, and within the lower vessel. Such an arrangement adds stability and decreases the height of the stacked vessels.

The aperture is sized to accept the top of the upper vessel, including a cap or pump cap if desired. The upper vessel rests on its shoulders on the coupler. In such a configuration, the upper vessel is held in place relative to the lower vessel and helps to prevent spills if the stacked vessels are inadvertently knocked over. Since the fluid travelling between the vessels is viscous, even though a non-air-tight seal is used between the aperture and the upper vessel, if the stacked vessels are righted quickly after being knocked over, little fluid will leak out. Further any fluid leaking from the first vessel would travel down the conical surface to the aperture once the stacked vessels are placed back upright.

Since bottles and other vessels containing viscous fluids are typically cylindrical, the coupler is preferably cylindrical and may have vertical cylindrical walls. Additionally, to function as a quasi-cap for the lower vessel, the coupler also preferably has a horizontal lid portion. To ensure that the spill resistant characteristics are preserved, the horizontal lid portion should ideally surround the conical surface surrounding the aperture. If the lower vessel is the intended final receptacle for the viscous fluid, labels, including dry erase labels may he included for adhesion to the lower vessel, and a lid may be provided for sealing the lower vessel.

In order to use the coupler to decant a viscous fluid, a user first covers the mouth of the lower vessel with the coupler in a manner such that access to the lower vessel is provided by the aperture. If a user installs the coupler by setting it upside down on a surface and engaged it with the mount of an inverted lower vessel, the resulting assembly may need to be inverted. The user inserts the coupler and lower vessel onto the upper vessel such that a portion of the upper vessel is inside the lower vessel. The assembly of the upper vessel, coupler and lower vessel should be prepared, inverted as necessary, so that the upper vessel is above the lower vessel.

Once installed, the stacked vessels may be left undisturbed in a convenient location while the user waits until all of the viscous fluid travels from the upper vessel to the lower vessel. Once the upper vessel is empty, it may be disengaged from the coupler. The coupler may be left on the lower vessel to function as a partial lid, or disengaged as desired. Also, the user may install a label, including a dry erase label, to mark the contents of the lower vessel after decantation.

### BRIEF DESCRIPTION OF THE FIGURES

FIG. 1 is a perspective view of a coupling device, coupled to two fluid vessels.

FIG. 2 is an exploded view of the coupling device used for transferring fluid between the vessels.

FIG. 3 is a cut-away view of the coupling device, coupled to the fluid vessels, the upper vessel being uncapped.

FIG. 4 is an exploded view of the coupling device used for urging fluid to the top of a vessel

FIG. 5 is a cut-away view of the coupling device, coupled to the fluid vessels, the upper vessel being capped.

FIG. 6 is a perspective view of the underside of the coupling device.

### REFERENCE NUMBERS

10. Coupler
12. Upper Vessel
14. Lower Vessel
16. Vessel Bottom
18. Aperture
20. Threads
22. Label
24. Bead
26. Viscous Liquid
28. Cylindrical Hammock
30. Horizontal Portion
32. Cap
34. Apron

### DESCRIPTION

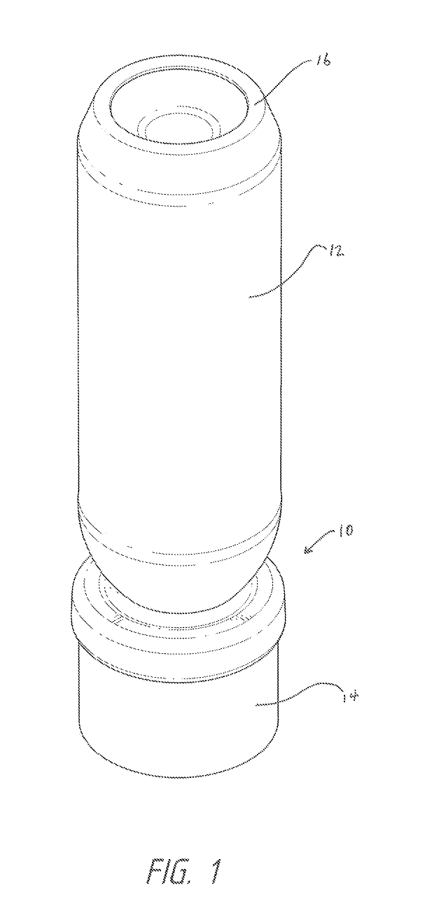

A coupler is disclosed for decanting viscous fluids from a narrow bottle having an elongate throat portion into a wider mouth jar container. Referring to FIG. 1, the coupler 10 is shown in use. The coupler 10 is installed between a upper vessel 12 containing a viscous fluid (not shown) and a lower vessel 14 for receiving the viscous fluid. The upper vessel 12 is inverted with the vessel bottom 16 on top. The coupler 10 preferably rests on and is supported by the rim (not shown) of the lower vessel 14, and supports the upper vessel 12. Once arranged in this configuration, the coupler 10, upper vessel 12 and lower vessel 14 may be stored in a convenient out-of-the-way place, and over time, the contents of the upper vessel 12 will descend into the lower vessel 14.

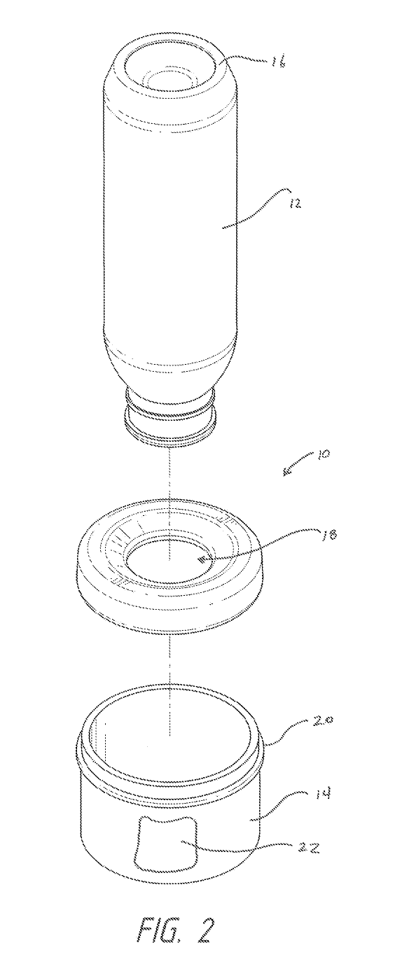

Referring to FIG. 2, the coupler 10 is adapted to receive an uncapped upper vessel 12 in an aperture 18 disposed centrally on the coupler 10. The inverted upper vessel 12 travels through the aperture 18 and comes to rest on the coupler 10. The coupler 10 is preferably resilient and therefore is able to travel over the threads 20 of the lower vessel 14, and be held thereon. The threads 20 are adapted to receive a cap (not shown) on the lower vessel 14 for containing a viscous fluid (not shown) once decanted. A label 22, preferably an erasable and reusable label 22 may be included on the lower vessel 14 for labeling its contents.

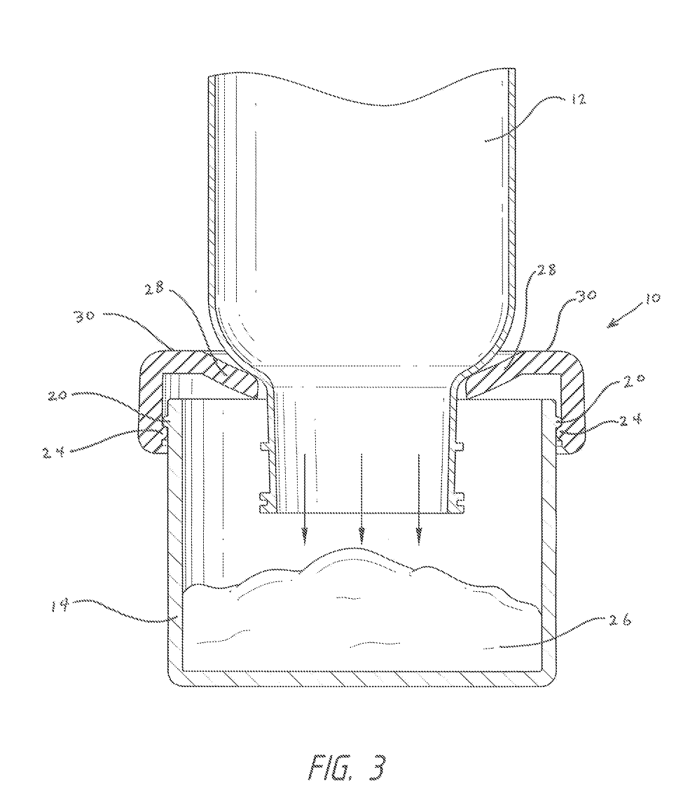

Referring to FIG. 3, a cross-sectional view shows the coupler 10 engaging a upper vessel 12 and installed over a lower vessel 14. In this view the coupler 10 is shown engaging the threads 20 of the lower vessel 14 with a bead 24. By engaging the lower vessel 14 the coupler prevents the viscous fluid 26 from spilling out of the lower vessel 14. As shown in this view, over time, the viscous fluid 26 will gradually travel under gravity from the upper vessel 12 to the lower vessel 14. Additionally, the aperture 18 is preferably sized to receive a pumped bottle if necessary.

Still referring to FIG. 3, the profile characteristics of the coupler 10 are shown. In particular, the coupler 10 preferably has a cylindrical hammock 28 which helps it hold the upper vessel 12 upright, and a horizontal portion 30 which serves as a partial cover for the lower vessel 14. The horizontal portion 30 allows the coupler 10 to be installed over a smaller vessel (not shown) which it does not engage. but provides balance for the coupler 10. In a preferred embodiment, the cover 10 is made of a thick fitted thermoplastic elastomeric material such as SANTOPRENE® or MONPRENE®, which allows for a tight fit around the lower vessel 14, helps hold the upper vessel 12 in place, and serves as a non-slip surface for the upper vessel 12.

The coupler 10 is preferably of low profile, with the horizontal portion 30 and cylindrical hammock 28 fairly thick. In this manner, if the lower vessel 14 is tipped over, a user can likely correct its position before fluid spills out of the aperture 18. In other embodiments, the coupler 10 may be elongated to fit a variety of container shapes. In a preferred embodiment the lower vessel 14 includes a lid (not shown) for storage and travel once the viscous liquid 26 is decanted.

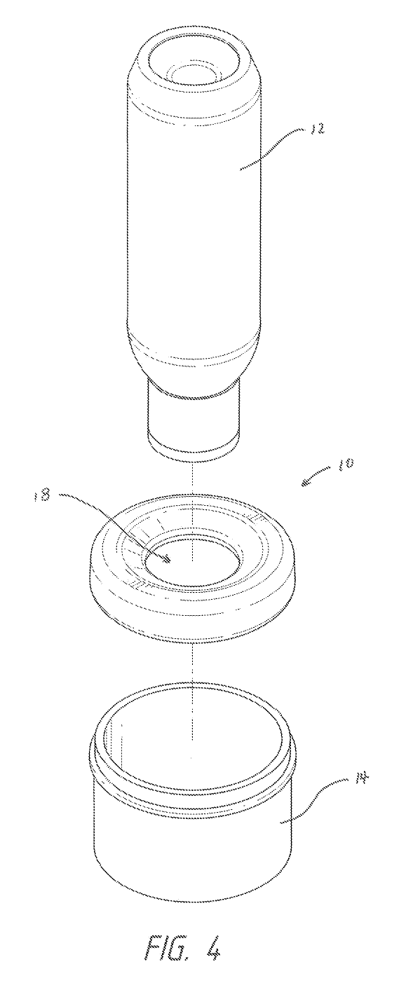

Referring to FIG. 4, the coupler 10 is adapted to receive a capped upper vessel 12 in an aperture 18 disposed centrally on the coupler 10 as well. The inverted upper vessel 12 travels through the aperture 18 and comes to rest on the coupler 10. In this configuration, the coupler 10 functions to receive the upper vessel 12 and the lower vessel 14 functions to hold up the coupler and provide a space for the upper vessel 12. Instead of receiving the viscous liquid (not shown) however, the capped upper vessel 12 retains the liquid. In this manner, the viscous liquid is ready to be dispensed as desired.

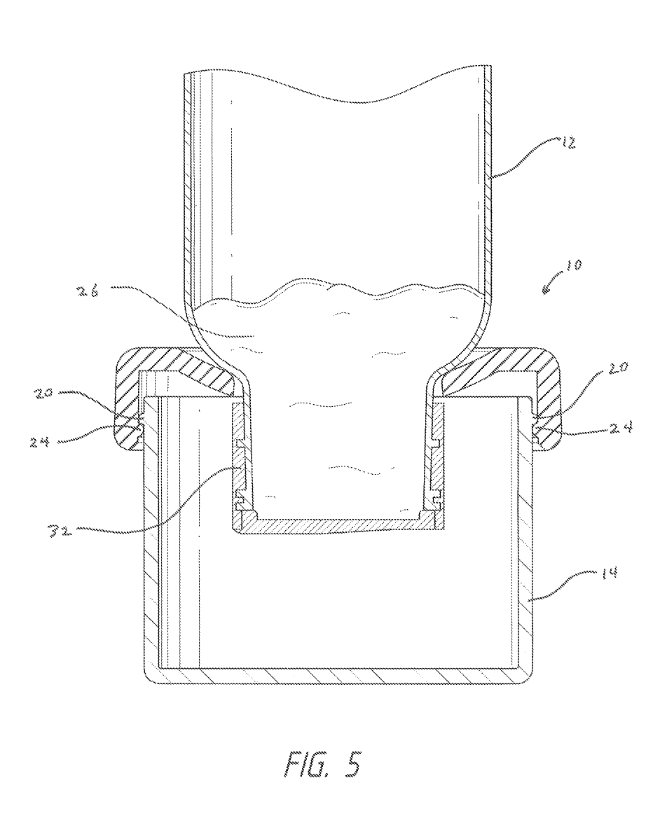

Referring to FIG. 5, a cross-sectional view shows the coupler 10 engaging a capped upper vessel 12 and installed over a lower vessel 14 is shown. In this view the coupler 10 is shown engaging the threads 20 of the lower vessel 14 with a bead 24. In this method, by engaging the lower vessel 14 the coupler holds the upper vessel 12 upside down and causes the viscous fluid 26 to collect near the cap 32 of the upper vessel 12, which prevents it from spilling out of the upper vessel 14 but prepares the viscous fluid 26 for easy decantation. In a preferred embodiment the coupler 10 is preferably sized to receive a pumped bottle if necessary.

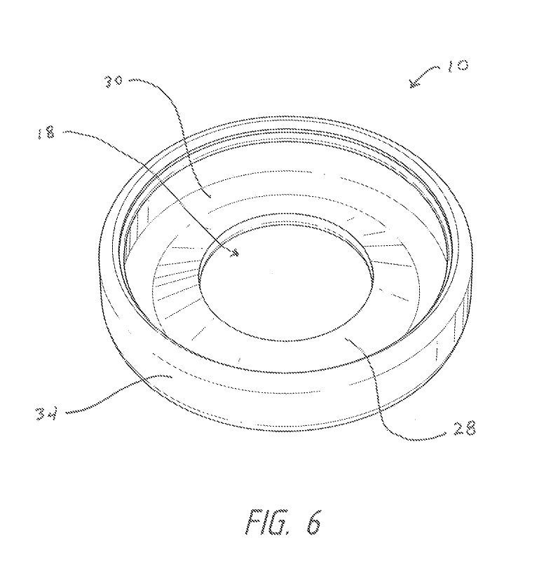

Referring to FIG. 6, the underside of the coupler 10 is shown. The coupler 10 is preferably of low profile, with a relatively short apron 34 for engaging the lower vessel (not shown). The horizontal portion 30 and cylindrical hammock 28 are, by contrast fairly thick. In this manner, if the lower vessel overturns, a user can likely correct its position before fluid spills out of the aperture 18. In other embodiments, the apron 34 may be elongated or even threaded to fit a variety of container shapes and sizes.

In order to use the coupler 10, a user simple engages the threads 20 of the lower vessel 14 with the bead 24 on the coupler 10. Then, with the lower vessel 14 standing upright, the user inverts the upper vessel 12 over the coupler 10 so as to engage the aperture 18. Once the upper vessel 12 and lower vessel 14 are connected to the coupler 10, any viscous fluid 30 in the upper vessel 12 will slowly travel toward the lower vessel 14. A user may invert an uncapped upper vessel 12 over the coupler, which will transfer its contents into the lower vessel 14 which may be capped, labeled and used for storage and travel, or a user may invert a capped upper vessel 12 over the coupler, which will transfer its contents toward the cap 32 of the upper vessel 12 ready for easy decantation. Because of the relatively thick nature of the horizontal portion 34, the coupler also functions as a cap-like structure for the lower vessel 14.

The coupler 10 may be easily and inexpensively manufactured by molding from a variety of semi flexible materials, including thick rubber or plastic. Additionally, because of the low profile of the coupler 10 it may be conveniently packaged and stored prior to sale, and after use.

The foregoing description of the preferred embodiment of the Invention is sufficient in detail to enable one skilled in the art to make and use the invention. It is understood, however, that the detail of the preferred embodiment presented is not intended to limit the scope of the invention, in as much as equivalents thereof and other modifications which come within the scope of the invention as defined by the claims will become apparent to those skilled in the art upon reading this specification.

What is claimed is:

1. A coupler for transferring viscous fluids from an upper vessel having a spout to a lower vessel having a mouth, comprising:
an engaging portion configured to encircle the mouth of the lower vessel;
an aperture configured to engage the spout of the upper vessel;
a generally conical surface between the engaging portion and the aperture; and
the coupler arranged such that, when the upper vessel is engaged to the coupler, a portion of the upper vessel is disposed below the mouth of the lower vessel and within the lower vessel.

2. The coupler of claim 1 wherein the aperture is wide enough to accept a pump cap.

3. The coupler of claim 1 further comprising a horizontal lid surface surrounding the conical surface.

4. The coupler of claim 1 further comprising a vertical cylindrical wall forming an outer perimeter of the coupler.

5. The coupler of claim 1 wherein the conical surface is a resilient thermoplastic polymer.

6. The coupler of claim 1 further comprising an erasable marker sticker for adhering to the lower vessel.

7. A method of transferring a viscous fluid from an upper vessel to a lower vessel comprising the steps of:
covering a mouth of the lower vessel with a coupler;
inverting the upper vessel;
inserting the coupler and the lower vessel onto the upper vessel, such that a portion of the upper vessel is inside the lower vessel;
waiting for the viscous fluid to drain into the lower vessel; and disengaging the upper vessel from the coupler.

8. The method of claim 7 further comprising the step of labeling the viscous fluid on the lower vessel.

9. The method of claim 7 further comprising the step of disengaging the coupler from the lower vessel.

10. The method of claim 7 further comprising the step of capping the lower vessel.
